(19) United States
(12) Patent Application Publication
(10) Pub. No.: US 2013/0139189 A1
(43) Pub. Date: May 30, 2013

(54) DISK DRIVE DEVICE

(71) Applicants: HITACHI CONSUMER ELECTRONICS CO., LTD., Tokyo (JP); HITACHI-LG DATA STORAGE, INC., Tokyo (JP)

(72) Inventors: Tatsuya YAMASAKI, Kashiwa (JP); Ikuo NISHIDA, Ebina (JP); Hideyuki NAGAMINE, Urayasu (JP); Koji MATSUMOTO, Kuala Lumpur (MY); Shinya ASANO, Tokyo (JP); Yoshiaki YAMAUCHI, Omitama (JP); Yasushi KINOSHITA, Hitachinaka (JP)

(73) Assignees: HITACHI-LG DATA STORAGE, INC., Tokyo (JP); HITACHI CONSUMER ELECTRONICS CO., LTD., Tokyo (JP)

(21) Appl. No.: 13/685,864

(22) Filed: Nov. 27, 2012

(30) Foreign Application Priority Data
Nov. 28, 2011 (JP) 2011-259138

(51) Int. Cl. G11B 17/056

(52) U.S. Cl. CPC G11B 17/056
USPC 720/613

(57) ABSTRACT

A disk drive device that can prevent warping deformation in upward and downward directions of a disk tray and can prevent vibration in a warping deformation mode without producing a rattle vibration is provided. A disk drive device has a casing and a disk tray on which the spindle motor and the pickup are mounted; and a pair of parallel first and second guide mechanisms that slidably supports the disk tray so as to eject the disk tray from the casing to the outside. In the disk drive device, in a center part in a width direction along the disk mount surface of an introduction side distal end part of the disk tray, an introduction side abutment part having a groove section or a protruding portion is formed, and an inner part abutment part formed on an elastic member is installed on an inner side inner wall part.

### BACKGROUND OF THE INVENTION

1. Field of the Invention

The present invention relates to a disk drive device that performs recording and reproduction of information. Specifically, the present invention relates to a tray-type disk drive device that has a disk mounted on a disk tray ejected from the casing of the device and introduces the disk together with the disk tray into the casing of the device.

2. Background Art

As a tray-type disk drive device, JP Patent Publication (Kokai) No. 2002-279717A (2002) discloses a configuration in which a lib-shaped abutment part is formed to project to the lower side in a height direction (thickness direction (upward and downward directions)), positioned in a center part of the width direction (left and right directions) on a back face with respect to the disk mount surface (front surface) of the disk tray, on the introduction side (back side of the front and back sides) of the introduction/ejection directions (front and back directions) of the disk tray, and a flat receiving part that can abut on the abutment part with a slight clearance therebetween on the chassis on the fixed side opposed to the abutment part at a disk clamp position. According to the structure, in the disk tray introduced at a disk clamp position with each of both sides in the width direction being guided, the lib-shaped abutment part is supported from the lower side by the receiving part of the chassis so that it is possible to prevent warping deformation of the center part in the width direction of the disk tray from being caused in the shape to project to the lower side by the self-weight.

Further, JP Patent Publication (Kokai) No. 2002-230955A (2002) similarly discloses a configuration of a tray-type disk drive device, in which, in the introduction side of the introduction/ejection directions of the disk tray, a U-shaped groove is provided on the end part, and a flange having flexure elasticity in the upward and downward directions of the disk tray extends in the introduction direction, and, on the bottom face of the casing in the fixed side in which the disk tray is introduced, a cylindrical boss stands, to which the U-shaped groove of the flange elastically fits when the disk tray is introduced to the disk clamp position. According to this, the flange of the disk tray having progressed to the disk clamp position, when the U-shaped groove of the flange is tightly fit to the circular conic surface of the cylindrical boss, can restrain vibration displacement toward the upper side of upward and downward directions of the disk tray by flexure elasticity of the flange produced by the flange end part in which the U-shaped groove is formed being pushed to the upper side in the vertical upward and downward directions against the bottom face of the casing in the fixed side.

Further, JP Patent Publication (Kokai) No. 2009-48698A (2009) similarly discloses, as a tray-type disk drive device, a configuration in which circuit connection between a first circuit board provided in the casing in the fixed side and a second circuit board provided in the disk tray is connected and disconnected in accordance with the introduction/ejection of the disk tray. According to this, when the disk tray is introduced, both side parts in the width direction (left and right directions) of the projection formed on the distal end part in the introduction side of the disk tray are guided by a positioning mechanism while engaging the concave portion formed on both side faces opposed in the width direction (left and right directions) of the casing so that connectors provided on the first and second circuit boards within the casing can be positioned to face to each other so that they can be fitted to each other.

### SUMMARY OF THE INVENTION

The disk drive device is mounted on devices including a personal computer (PC) or a game machine, image recording/reproducing devices and car navigation systems, etc., as information recording and reproducing device therefor. Therefore, various vibrations such as various extraneous vibrations based on operating environments of the installed devices, and vibrations from other component device built-in together with, for example, installed devices including cooling fans or speakers act on the disk drive device. Since these vibrations include vibrations of various frequency bands, there is a possibility that components constituting the disk drive device are vibrated by the specific natural mode of vibration thereof. In particular, since the disk trays are movably supported to enable introduction/ejection thereof against the casing in the fixed side for introduction and ejection of the disk, the tray-type disk drive devices, when vibrated at the specific natural mode of vibration causes a resonance phenomenon in which the center part in the width direction of the disk tray produces vibration displacement to the upward and downward directions while undergoing warping deformation. The amplitude of the vertical vibration in the width direction in the central part of the disk tray in the warping deformation mode caused by the resonance phenomenon, is large, causing the recording/reproduction error by excitation of the pick up that records information on the disk and reproduces the information on the disk, and causing, problem including increased noise due to rattle vibration.

However, in the conventional disk drive devices, there has been no sufficient consideration on the vertical vibration in the center part in the width direction of the disk tray in the warping deformation mode due to the resonance phenomenon.

For example, the technique described in JP Patent Publication (Kokai) No. 2002-279717A (2002) is nothing more than a technique to prevent warping deformation of the center part in the width direction of the disk tray by self-weight into a shape projecting to the lower side at the disk clamp position. Therefore, the warping deformation of the shape in which the center part in the width direction of the disk tray projects upwardly is not considered at all. Consequently, it has not been possible to restrain resonance phenomenon in the center part in the width direction of the disk tray causing warping deformation of the center part in the width direction of the disk tray while producing vibration displacement in the vertical directions, not only in the downward direction, but also the upward direction.

Further, in the technique described in JP Patent Publication (Kokai) No. 2002-230955A (2002), the U-shaped groove of the flange integrally formed with the disk tray is tightly fit on the circumferential surface of the cylindrical boss that stands on the bottom face of the casing in the fixed side to which the disk tray is opposed at the disk clamp position, so that when the vibration displacement toward the upper side of the upward and downward directions is to be produced in the disk tray, the flexure elasticity of the elastically bending flange presses the disk tray toward the lower side that is the side of the bottom face of the casing with the portion tightly fit with the U-shaped groove and the circular conic surface of the cylindrical boss as the support point, to restrain the vibration displacement of the disk tray to the upper side. However, when a resonance phenomenon is caused in which the center part in the width direction of the disk tray produces vibration displacement in the upward and downward directions while causing warping deformation, even if it is possible to restrain the warping deformation of the center part in the width direction of the disk tray to the upper side by the flexure elasticity of the flange, it is not possible to restrain the resonance phenomenon by the warping deformation in the center part in the width direction of the disk tray to the lower side, since flexure elasticity of the flange is released to enhance the warping deformation of the center part in the width direction of the disk tray to the lower side. Further, when a minute clearance is produced in the tightly fit portion between the U-shaped groove of the flange and the circular conic surface of the cylindrical boss by the flexure elasticity of the flange being released, what is called rattle vibration is produced in which the U-shaped groove of the flange vibrates while colliding with the circular conic surface of the cylindrical boss.

Further, in the technique described in JP Patent Publication (Kokai) No. 2009-48698A (2009), the both sides in the width direction of the projection formed on a distal end part in the introduction side of the introduction/ejection directions of the disk tray serve as a positioning mechanism between the disk tray, which is guided by engaging the concave portion formed on the side faces of both sides opposed in the width direction in the casing, and the casing. However, the positioning mechanism is nothing more than an improvement of the guide mechanism for introduction/ejection of the disk tray, and it cannot restrain the resonance phenomenon that produces vibration displacement of the center part in the width direction of the disk tray in the upward and downward directions.

The present application was made in view of the aforementioned problems, and an object of the present application is to provide a disk drive device that prevents warping deformation in the upward and downward directions in the center part in the width direction of the disk tray while being able to restrain resonance phenomenon that causes warping deformation in the center part in the width direction of the disk tray while producing the vibration displacement of the center part in the width direction of the disk tray in the upward and downward directions.

In order to overcome the above-stated problems, the present invention is featured by a disk drive device that performs recording and reproduction of information, in particular, a tray-type disk drive device that has a disk mounted on a disk tray ejected from the casing of the device and introduces the disk together with the disk tray inside the casing of the device, comprising a warping deformation restraining mechanism comprising an introduction side abutment part formed in a center part in the width direction of the disk tray in a distal end part in the introduction side of the introduction/ejection directions of the disk tray against the device casing so as to be opposed to an inner side inner wall part in the introduction side of the device casing and an inner part abutment part disposed on the inner side inner wall part in the introduction side in the device casing so as to be opposed to the introduction side abutment part of the disk tray and abutting and engaging introduction side abutment part of the disk tray at a predetermined introduction position in the disk tray, wherein in the warping deformation restraining mechanism, the introduction side abutment part is elastically supported from both the upper and lower sides by the inner part abutment part in an ordinary mode in which the introduction side abutment part and the inner part abutment part abut on and engage with each other by forming by an elastic member both abutment surfaces in the upward and downward sides of either one of the introduction side abutment part and the inner part abutment part.

According to the present invention, it is possible to prevent the warping deformation in both upward and downward directions of the center part in the width direction of the disk tray, and it is possible to restrain resonance phenomenon that causes warping deformation of the center part in the width direction of the disk tray while producing vibration displacement of the center part in the width direction of the disk tray in the upward and downward directions.

Further, by this, it is possible to prevent recording/reproduction error due to excitation of the pick up for recording information on the disk and reproducing the information on the disk and prevent increased noise due to a rattle vibration.

### BRIEF DESCRIPTION OF THE DRAWINGS

FIG. 1 is an exploded perspective view of an optical disk drive device as one embodiment of the present invention.

FIG. 2 is a schematic diagram of one embodiment of a rattle vibration prevention part formed on a slide surface of a guide rail.

FIG. 3 is an illustration of warping deformation in the upward and downward directions of the central part of a disk tray, and resonance phenomenon.

FIG. 4 is a schematic diagram of a first embodiment of a warping deformation restraining mechanism provided on the optical disk drive device.

FIG. 5 is a schematic diagram of a second embodiment of the warping deformation restraining mechanism provided on the optical disk drive device.

FIG. 6 is a schematic diagram of a third embodiment of the warping deformation restraining mechanism provided on the optical disk drive device.

FIG. 7 is a schematic diagram of a fourth embodiment of the warping deformation restraining mechanism provided on the optical disk drive device.

FIG. 8 is a schematic diagram of a fifth embodiment of the warping deformation restraining mechanism provided on the optical disk drive device.

### DETAILED DESCRIPTION OF THE PREFERRED EMBODIMENTS

Hereafter, a disk drive device of an embodiment of the present invention will be explained based on the drawings. In the following explanations, an optical disk drive device is explained as an example. However, the configuration of the principal part thereof is applicable to other disk drive devices. Among the drawings, same or similar configuration parts are provided with same reference signs, and duplicating explanations therefor are omitted.

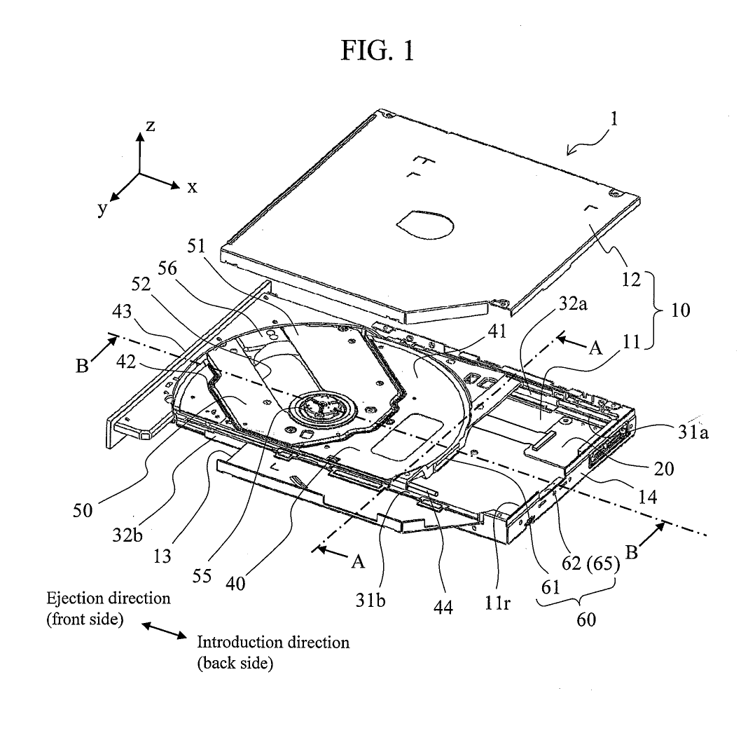

FIG. 1 is a perspective view showing a configuration of an optical disk drive device according to one embodiment of the present invention.

The optical disk drive device 1 is configured so that a disk tray 40 of a state in which an optical disk is mounted thereon can be introduced/ejected to/from the casing of the thin box-shape casing (device casing) 10.

Inside of the casing 10 is configured so that components including a circuit board 20, etc. on which electronic components including a Central processing Unit (CPU) that controls connectors or each part of the device is implemented are disposed and so that a disk tray 40 on which an optical disk is mounted is housed so as to be freely introduced thereto or ejected therefrom. Therefore, in the casing 10, a casing surface part corresponding to the frontage (front face) of the optical disk apparatus 1 is an opening 13 for introducing the disk tray 40 of a state in which an optical disk is mounted thereon to inside of the casing 10, and ejected from within the casing 10.

The casing 10 is made by coupling a bottom casing 11 formed by press casting of a thin metal plate of aluminum, etc., and a top casing 12. For example, the size of the casing 10 is, when viewed from the front face, approximately, with the width of 130 mm, the length in depth of 130 mm, height (thickness) of 12.7 mm (or 9.5 mm), which is a size applicable to a slim-type drive, or a super slim-type drive installed in the mobile-type personal computer.

Here, x direction, y direction, and z direction shown by arrows in the drawings correspond to the introduction/ejection directions of the optical disk drive device 1 (hereafter also referred to as front and back directions), a width direction (hereafter also referred to as left and right directions), a height (thickness) direction (hereafter referred also to upward and downward directions), at the time when the opening 13 of the casing 10 to and from which the disk tray 40 is introduced/ejected is viewed from the front.

On a pair of inner wall sections that are opposed to each other of both sides in the width direction (y direction) of the casing 10, in the example of the illustration, a pair of inner wall sections that are opposed to each other of both sides in the width direction (y direction) of the bottom casing 11, guide rails 31 (31a, 31b) made of resin that guide and support the disk tray 40 so as to be movable along the introduction/ejection directions (x direction) are respectively attached and fixed. On the pair of parallel guide rails 31 (31a, 31b), both end sides in the width direction (y direction) of the disk tray 40 made of resin are supported via rack slides 32 (32a, 32b) made of a thin metal plate of aluminum, etc.

Each of rack slides 32a, 32b is engaged with corresponding one of the guide rails 31a, 31b and movably supported on the guide rail 31 along the lengthwise direction of the guide rail 31, in other words, introduction/ejection directions of the optical disk drive device 1 (x direction). On the other hand, the rack slides 32a, 32b engage with the corresponding distal end part of each of both sides in the width direction (y direction) of the disk tray 40, and movably support the disk tray 40 along the lengthwise direction of the rack slide 32, in other words, introduction/ejection directions of the optical disk drive device 1 (x direction). On the rack slide 32, for smooth sliding, some clearances (freeplay) in the height direction (z direction) and the width direction (y direction) are provided against corresponding distal end parts of both sides in the width direction (y direction) of the guide rail 31 and the disk tray 40 that engage with each other.

On the other hand, on the disk tray 40, on the top face with respect to the height direction (z direction), an optical disk mount part 41 on which an optical disk is mounted is defined by an arcuate circumferential wall part as a concave part. The inner diameter of the optical disk mount part 41 is slightly larger than the outer diameter of the optical disk to be mounted thereon. The optical disk is mounted on the optical disk mount part 41 in such a state that a part is laid off the edge of the chord of arc of the optical disk mount part 41, that is, the corresponding one side in the width direction (y direction) of the disk tray 40. On the disk tray 40, an opening 42 for placing a later-described unit mechanism 50 to face the optical disk mounted on the optical disk mount part 41 is formed.

Further, to the ejection side distal end part in the front end of the disk tray 40 is attached and fixed a front bezel 43 made of a resin that hides the opening 13 of the casing 10 from the exterior and defines a space within the casing 10 in a state that the disk tray 40 is housed in the casing 10. On the front face of the front bezel 43 not shown, an eject button operated when the disk tray 40 housed in the casing 10 is ejected from within the casing 10 is disposed.

Further, to the disk tray 40, a disk tray extruder mechanism 44 is mounted. The disk tray extruder mechanism 44 has a rod that can be pushed into the front side of the front and back directions (x direction) of the disk tray 40 and an elastic member including a coil spring that urges the rod into the back side of the front and back directions (x direction). The disk tray extruder mechanism 44 is structured so that the elastic member thereof contracts with respect to its natural length when the rod is pushed into the front side.

By this, the disk tray extruder mechanism 44 is configured so that, when the disk tray 40 is manually introduced from the outside to the inside of the casing 10, at the outset of introduction, in accordance with the movement and displacement to the introduction side of the disk tray 40, the rod is moved and displaced to the introduction side in the casing 10 together with the disk tray 40. In addition to this configuration, the rod is configured so that the movement and displacement to the introduction side in the casing 10 is prohibited preceding to the disk tray 40, for example, by abutment on the internal face of the back wall 14 of the bottom casing 11, etc. The disk tray extruder mechanism 44 is configured so that the rod whose movement to the introduction side is regulated in accordance with the further movement and displacement after the above-stated movement of the disk tray 40 to the introduction side (inner side) in the casing 10 toward the predetermined introduction position (disk clamp position), is then pushed in a relatively front side (forward side) with respect to the disk tray 40. By this, the disk tray extruder mechanism 44 is configured so that the elastic member which has been in the natural length at the outset of the introduction is contracted by interlocking with pushing of the rod from the introduction position that is more forward than a predetermined introduction position of the disk tray 40.

Further, reproduction of information recorded on the optical disk and recording of information in the optical disk are performed when the disk tray 40 is introduced to a predetermined introduction position within the casing 10. Therefore, during the reproduction of information or recording thereof, it is necessary that the disk tray 40 disposed in the predetermined introduction position be not ejected therefrom by returning of the aforementioned contracted elastic member to the natural length. Therefore, the casing 10 is provided with a locking mechanism of the disk tray 40 (not shown).

The locking mechanism is configured so that, when the disk tray 40 is introduced to a predetermined introduction position, the disk tray 40 is once maintained in the predetermined introduction position with the contracted elastic member of the disk tray extruder mechanism 44 being in a contracted state resisting against the returning force. The locking mechanism is operated by a latch mechanism that is not shown when the disk tray 40 is introduced in the predetermined introduction position, and locks the movement to the ejection side of the disk tray 40.

The locking mechanism is configured so that, when the disk tray 40 is ejected to the outside of the casing 10 in order to attach and detach the optical disk, the lock is released. When the CPU on the circuit board 20 supplies unlocking instruction by detecting operation of an ejection button on the front face of the front bezel 43, or input of ejection instruction from the outside interconnect equipment, the locking mechanism is unlocked. When unlocking of the locking mechanism is performed, in the disk tray extruder mechanism 44, the elastic member can return to the original natural length from the contracted state, and the restoring force of the elastic member at this time positions the disk tray 40 outside the casing 10 by ejecting it from the opening 13 of the casing 10 so that the front bezel 43 and the front side of the disk tray can be extracted.

The unit mechanism 50 is configured so that a spindle motor 55 for rotating the optical disk, an optical pickup 56 that reproduces the information on the recording surface of the optical disk or records the information on the recording surface of the optical disk, a guide mechanism that is not shown and that moves the optical pickup 56 along the disk diameter direction, or the like are mounted on the mechanism chassis that is not shown and each of whose upper and lower surfaces is covered by a unit cover 51 and an under cover that is not shown. On the unit cover 51, a cut-out section 52 extending in the diameter direction of the arcuate circumferential wall part of the optical disk mount part 41 is formed. The spindle motor 55 is disposed in the cut-out section 52 with its clamper disposed on the rotational axis being adjusted to agree with the arc central portion of the arcuate circumferential wall part of the optical disk mount part 41. The optical pickup 56 is disposed in the cut-out section 52 so as to be freely movable along the diameter direction of the arcuate circumferential wall part of the optical disk mount part 41 by a guide mechanism that is not shown.

The unit mechanism 50 is attached and fixed to the lower surface of the disk tray 40 with respect to the height direction (z direction) via a plurality of insulators that are not shown and formed of an elastic material. By the plurality of insulators, it is possible to attenuate vibration or impact conducting to the unit mechanism 50 from the other part of the device or vibration or impact conducting to the other part of the device from the unit mechanism 50.

By the way, at the predetermined introduction position at which the movement of the disk tray 40 is locked by the locking mechanism, the above-stated clearance (freeplay) for smooth sliding between the rack slides 32 (32a, 32b) and guide rails 31 (31a, 31b) and each of distal end parts in both sides in the width direction (y direction) of the disk tray 40 is configured so as to be restrained by the rattle vibration prevention part 33 formed on each of slide surfaces of the back side in the front and back directions (x direction) of the guide rail 31 (31a, 31b).

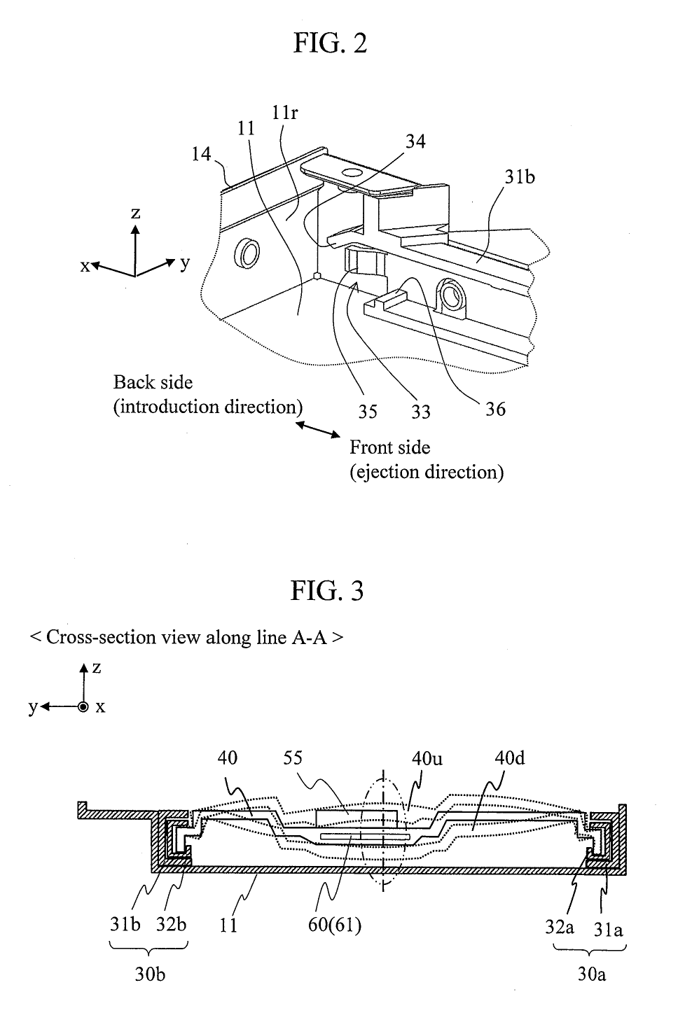

FIG. 2 is a schematic diagram showing one embodiment of the rattle vibration prevention part formed on the slide surface of the guide rail. Although FIG. 2 shows a configuration of the rattle vibration prevention part 33 formed on the slide surface of the back side in the front and back directions (x direction) of the guide rail 31b, the rattle vibration prevention part 33 on the guide rail 31b side has a similar configuration.

In FIG. 2, the pressing claw portions 34, 35 and constituting the rattle vibration prevention part 33 and having a spring-like characteristic and a stopper projection 36 are integrally formed in the rearward part in the front and back directions (x direction) of the guide rail 31b made of a resin and having a slide surface having a C-shaped cross-section viewed along the introduction/ejection directions (x direction).

The pressing claw portion 34 has a claw structure in which it extends from the back side of the slide surface to the inner side within the casing 10 to form an inclined surface that is inclined from the upside slide surface to the lower part slide surface side. On the other hand, the pressing claw portion 35 has a claw structure in which it extends from the back side of the slide surface to the inner side within the casing 10 to form the inclined surface that is inclined from the side of the slide surface to the open side in the C-shaped cross-section. The stopper projection 36 projects to the back side of the lower part slide surface and engages the corresponding distal end part of one side in the width direction (y direction) of the disk tray 40 that moves in the introduction side in the casing 10 (inner side), and the rack slide 32b.

By this, the disk tray 40 and rack slide 32b are pressed by abutting on the inclined surface of a pressing claw portion 34 having a spring-like characteristic, at a predetermined introduction position at which the movement of the disk tray 40 is locked by the locking mechanism, to be pressed by the lower part of the slide surface of the guide rail 31b. On the other hand, by being pressed by abutting the inclined surface of the pressing claw portion 35 having the spring-like characteristic, the disk tray 40 and rack slide 32b are sandwiched by both claw portions 35, 35 in cooperation with the pressing claw portion 35 of the guide rail 31a having the similar configuration. Therefore, at the predetermined introduction position where the movement of the disk tray 40 is locked by the locking mechanism, and at the disk clamp position where the reproduction of information and recording of information are performed on the optical disk, the clearances (freeplay) among the rack slide 32 (32a, 32b), each of distal end parts on both sides of the width direction (y direction) of the guide rail 31 (31a, 31b) and the disk tray 40 are prohibited, and the rattle vibration of the disk tray 40 caused by the clearances is to be restrained. In this process, the stopper projection 36 prohibits the excessive sliding of the slide surface to the back side of the guide rail 31 (31a, 31b) and the rack slide 32 (32a, 32b) to protect the pressing claw portions 34, 35.

The optical disk drive device 1 according to the present embodiment is featured by preventing the warping deformation in the upward and downward directions (z direction) of the central part in the width direction (y direction) of the disk tray 40 at the predetermined introduction position at which the movement of the disk tray 40 is locked by the locking mechanism, which is unsolvable alone by the rattle vibration prevention part 33 explained in FIG. 2, while restraining the resonance phenomenon that causes warping deformation of the center part in the width direction (y direction) of the disk tray 40 and produces vibration displacement in upward and downward directions (z direction) of the center part in the width direction (y direction) of the disk tray 40.

The disk drive device including the optical disk drive device 1 is mounted on devices such as PCs, as a component thereof. Therefore, on the optical disk drive device 1, various vibrations such as various extraneous vibrations based on the operating environment of the installed device and vibrations from other components installed together with the installed device are applied. Since these vibrations include vibrations of various frequency bands, in the optical disk drive device 1, even in the state in which rattle vibration caused by clearance (freeplay) produced on each distal end part in both sides in the width direction (y direction) of the disk tray 40 is restrained by the rattle vibration prevention part 33 shown in FIG. 2, at a predetermined introduction position where reproduction of information and recording of information are performed on the optical disk, if the disk tray 40 or parts mounted on the disk tray 40 are vibrated by the specific natural mode of vibration, there is a fear that the warping deformation in the upward and downward directions (z direction) of the central part in the width direction (y direction) of the disk tray 40, or resonance phenomenon that produces vibration displacement of the center part in the width direction (y direction) of the disk tray 40 in the upward and downward directions (z direction).

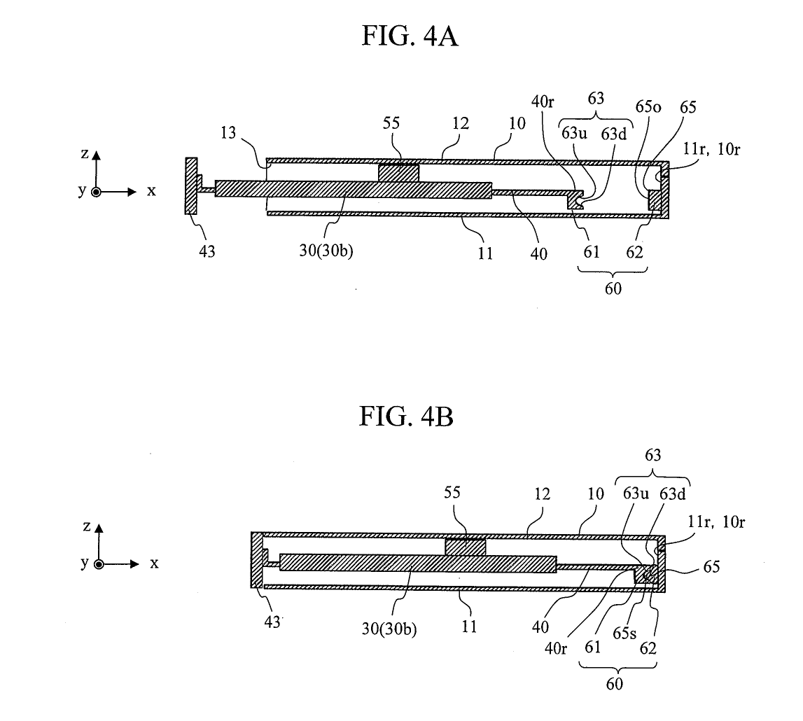

Here, warping deformation in the upward and downward directions (z direction) of the central part in the width direction (y direction) of the disk tray 40, and the resonance phenomenon are explained based on FIG. 3.

FIG. 3 is an illustration of the warping deformation in the upward and downward directions (z direction) in the central part of the disk tray and the resonance phenomenon. FIG. 3 is a general cross-section in which, unlike the ejection state illustrated in FIG. 1, the optical disk drive device 1 of a state in which the movement of the disk tray 40 is locked by the locking mechanism, and the disk tray 40 is introduced in the predetermined introduction position is viewed in the directions shown by arrows A-A in FIG. 1.

In FIG. 3, dashed lines 40u and dashed lines 40d schematically show a deformation mode of the disk tray 40 in the case where a resonance phenomenon is caused in which vibration displacement of the center part in width direction (y direction) of the disk tray 40 is produced in the upward and downward directions (z direction), while the disk tray 40 is vibrated at a specific natural mode of vibration thereof, causing warping deformation in the upward and downward directions (z direction) of the center part in the width direction (y direction) of the disk tray.

The deformation mode of the disk tray 40 at the time when the disk tray 40 or parts mounted on the disk tray 40 are vibrated at the specific natural mode of vibration thereof at the predetermined introduction position is a mode of vibration in which the center part in the width direction (y direction) is warped in the curved shape to the upper side and lower side of the upward and downward directions (z direction) with both distal end parts in the width direction (y direction) of the disk tray 40 supported by the first guide mechanism 30a comprising the guide rail 31a and the rack slide 32a and a second guide mechanism 30b comprising a guide rail 31b and a rack slide 32b serving as a support point as shown in FIG. 3.

In this case, vertical amplitude at a part including the position and part of the disk tray 40 whose distance along width direction (y direction) is substantially equal from both of the first guide mechanism 30a and the second guide mechanism 30b (the part encircled by a chain double-dashed line in FIG. 3) specifically becomes larger than those in the peripheral parts thereof. Then, the position and the part of the disk tray 40 whose distances along the width direction (y direction) from both the first guide mechanism 30a and the second guide mechanism 30b are substantially equal is offset with respect to the width direction (y direction) of the disk tray 40 so as to be closer to the first guide mechanism 30a than the position of the rotational axis of the spindle motor 55 in FIG. 3, in other words, offset to the side in which the unit mechanism 50 is disposed (right side in FIG. 3). Therefore, the recording/reproduction errors are likely to occur.

The optical disk drive device 1 according to the present embodiment is featured by comprising a warping deformation restraining mechanism 60 that restrains the warping deformation mode of the disk tray 40 due to the resonance phenomenon.

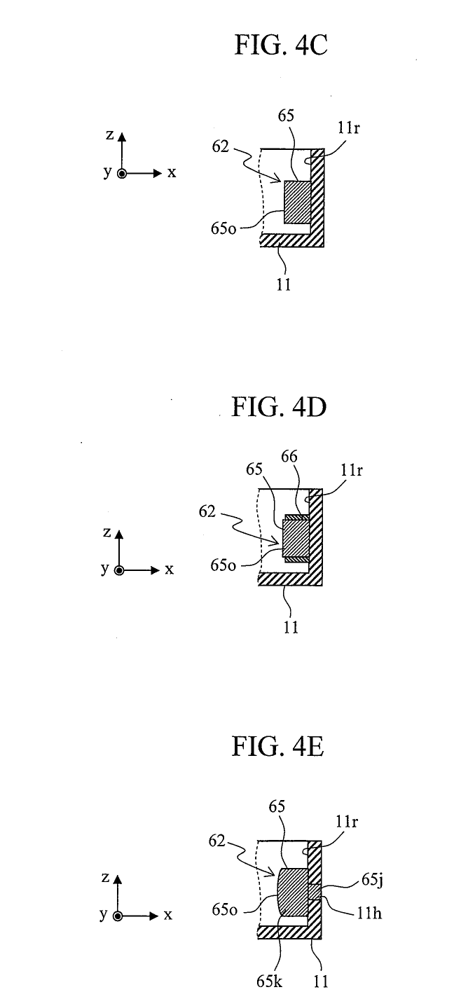

FIG. 4 is a schematic diagram of the warping deformation restraining mechanism of the first embodiment, which is a general cross-section of the optical disk drive device viewed in the direction indicated by arrows B-B in FIG. 1. FIG. 4A shows a state where the disk tray is ejected to the outside from the opening of the casing, FIG. 4B shows a state where the disk tray is introduced to the predetermined introduction position within the casing, and retained in a predetermined introduction position by a locking mechanism that is not shown, by resisting to urging force of the disk tray extruder mechanism, and FIG. 4C-4D show magnification of an inner part abutment part of the warping deformation restraining mechanism according to the present embodiment.

The warping deformation restraining mechanism 60 is configured to comprise an introduction side abutment part 61 provided in the disk tray 40 side and an inner part abutment part 62 provided in the casing 10 side. The introduction side abutment part 61 is disposed in the center part in the width direction (y direction) of the disk tray 40 of the introduction side distal end part (back side distal end part) 40r in the introduction/ejection directions (x direction) of the disk tray 40. The inner part abutment part 62 is disposed so that the inner side inner wall part 10r of the casing 10 to which the introduction side distal end part 40r of the disk tray 40 is opposed is opposed to the introduction side abutment part 61.

The introduction side abutment part 61 of the disk tray 40 side and the inner part abutment part 62 of the casing 10 side are configured to abut on and engage with each other at a predetermined introduction position in the introduction direction of the disk tray 40, in other words, the introduction position at which the movement in the ejection direction of the disk tray 40 by the above-described disk tray extruder mechanism 44 is locked by the locking mechanism. By the abutment and engagement of both elements, the warping deformation restraining mechanism 60 prevents the center part in the width direction (y direction) of the disk tray 40 from warping in the upward and downward directions (z direction) into the curved shape to the upper side and lower side. In the state where the disk tray 40 is ejected from within the casing 10, the introduction side abutment part 61 of the disk tray 40 is spaced apart from the inner part abutment part 62 of the casing 10, and both parts are configured to come close to each other in accordance with the introduction of the disk tray 40 into the casing 10. Hereafter, the warping deformation restraining mechanism 60 will be explained in detail.

As shown in FIG. 4A, the introduction side abutment part 61 of the warping deformation restraining mechanism 60 is disposed in the center part in the width direction (y direction) of the disk tray 40 and integrally formed with the disk tray 40 made of a resin in the introduction side distal end part 40r in the introduction/ejection directions (x direction) of the disk tray 40 as shown in FIG. 3. On the abutment surface facing in the ejection direction of the introduction side abutment part 61, a groove section 63 extending along the width direction (y direction) of the disk tray 40 is formed. The groove section 63 has a cross-section of U-shape when viewed along the width direction (y direction) of the disk tray 40. The U-shaped open section of the groove section 63 faces the inner side inner wall part 10r of the casing 10, and mutually opposed side-wall parts 63u, 63d of the U-shape are positioned upper side and lower side in the height direction (z direction) of the disk tray 40.

On the other hand, in the example of illustration, the inner part abutment part 62 is fixed to the inner side inner wall part 11r of the bottom casing 11 so that the height position in the height direction (z direction) and the position in the width direction (y direction) is adjusted to face the introduction side abutment part 61 of the disk tray 40.

Example of methods applicable for fixing the inner part abutment part 62 against the inner side inner wall part 11r of the bottom casing 11 include various fixation methods, such as, adhesively fixing the back surface of the inner part abutment part 62 to the inner side inner wall part 11r of the bottom casing 11 by adhesive or double sided tape, etc., or, forming a fitting hole on the inner side inner wall part 11r of the bottom casing 11, to fit the back surface side of the inner part abutment part 62 in the fitting hole by press-fit.

The inner part abutment part 62 is composed of an elastic member 65 comprising an elastic material in the present embodiment. Here, as the elastic member 65, for example, elastic materials, such as, rubber or felt are utilized. The elastic member 65 has a specifically high vibration-proof effect if formed of a material whose attenuation coefficient is large.

In the inner part abutment part 62, the elasticity surface 65o serving as the abutment surface is elastically deformed by being pressed by the abutment of the introduction side abutment part 61 of the disk tray 40 introduced to evaginate within the groove section 63 having a U-shaped cross-section of the introduction side abutment part 61, and in the state where the disk tray 40 is introduced to the predetermined introduction position within the casing 10, as shown in FIG. 4B, the entrapped part 65s entrapped within the groove section 63 abuts on both the side-wall parts 63u, 63d of the groove section 63. In addition to the above, the inner part abutment part 62 has a structure having vibration-damping (vibration-proof) properties to restrain the vibration when the introduction side abutment part 61 integrally formed with the disk tray 40 is to vibrate in the height direction (z direction) in the upward and downward sides when it abuts on both side-wall parts 63u, 63d of the groove section 63.

For example, the inner part abutment part 62 comprises an elastic member 65 formed to have an elastic deformation property by which it can be entrapped in the groove section 63 formed on the introduction side abutment part 61 of the disk tray 40, as shown in FIG. 4C, and to have vibration-damping (vibration-proof) properties that can absorb energy of vertical vibration of the introduction side abutment part 61. As the elastic member 65, for example, elastic materials including rubber and felt can be utilized. The elastic material of the elastic member 65, when formed of a material with a large attenuation coefficient, achieves particularly high vibration damping effect.

By this, the inner part abutment part 62 is to be pressed on the inner side inner wall part 11r side of the bottom casing 11 after abutting on the introduction side abutment part 61 of the disk tray 40 having introduced and in accordance with the introduction of the disk tray 40 to the predetermined introduction position within the casing 10. In this process, in the elastic member 65 of the inner part abutment part 62, the pressed part of the elasticity surface 65o is deformed by pressure to the inner side inner wall part 11r side with respect to the introduction/ejection directions (x direction), as shown in FIG. 4B, and the periphery will be entrapped into the U-shaped groove section 63 in the introduction side abutment part 61 by evaginatingly being deformed to the disk tray 40 side. Then, the entrapped part 65s abuts on the side-wall parts 63u, 63d opposed to each other in the height direction (z direction) of the groove section 63, and it becomes possible to elastically support the side-wall parts 63u, 63d in the upper direction and lower direction in the height direction (z direction) by the elastic force thereof. Therefore, at the predetermined introduction position where the movement in the introduction/ejection directions (x direction) of the disk tray 40 is locked by the locking mechanism (disk clamp position), the state in which the elastic member 65 of the inner part abutment part 62 is entrapped in the groove section 63 of the introduction side abutment part 61 of the disk tray 40, and the entrapped part 65s abuts on the side-wall parts 63u, 63d opposed to each other in the height direction (z direction) of the groove section 63, and supports the side-wall parts 63u, 63d in the upward and downward directions of the height direction (z direction) by the elastic force, is the ordinary mode.

As a result, in the ordinary mode of the elastic member 65 at the predetermined introduction position, when the introduction side abutment part 61 of the disk tray 40 is displaced upwardly and the warping deformation in the upward and downward directions (z direction) of the center part in the width direction (y direction) of the disk tray 40 is to be caused, a restraining force restraining the introduction side abutment part 61 of the disk tray 40 from being displaced to the upper side acts by receiving the elastic pressure (force to restore the ordinary mode) from the entrapped part 65s of the elastic member 65 abutting on the side-wall parts 63d of the groove section 63 of the introduction side abutment part 61. Therefore, it is possible to restrain warping deformation to the upper side of the center part in the width direction (y direction) of the disk tray 40. Similarly, for warping deformation of the center part in the width direction (y direction) of the disk tray 40 to the lower side, an elastic pressure (force to restore the ordinary mode) is received from entrapped part 65s of the elastic member 65 abutting on the side-wall parts 63u of the groove section 63 of the introduction side abutment part 61 and a restraining force restraining displacement to lower side of the introduction side abutment part 61 of the disk tray 40 acts. Therefore, it is possible to restrain the warping deformation of the center part in the width direction (y direction) of the disk tray 40 to the lower side.

Also when the disk tray 40, or a part mounted on the disk tray 40 is vibrated at the specific natural mode of vibration, an entrapped part 65s of the elastic member 65 entrapped in the groove section 63 of the introduction side abutment part 61 and abutting on the side-wall parts 63d, 63u, causes elastic pressing force in the direction inverse to the displacement direction (force to restore the ordinary mode) to act on the introduction side abutment part 61 that is to produce vibration displacement in the upward and downward directions (z direction) at the specific natural mode of vibration. Therefore, it is possible to restrain resonance phenomenon that produces vibration displacement of the center part in the width direction of the disk tray in the upward and downward directions.

Further, in this way, when the warping deformation in the upward and downward directions (z direction) of the center part in the width direction (y direction) of the disk tray 40 is restrained, in the groove section 63 of the introduction side abutment part 61, the entrapped part 65s of the elastic member 65 abuts also on the side-wall parts 63u (or 63d) in the opposite side of the side-wall parts 63d (or 63u) receiving the elastic pressure, and the entrapped part 65s of the elastic member 65 and the side-wall parts 63d, 63u of the groove section 63 of the introduction side abutment part 61 are not spaced from one another, and therefore there is no rattle vibration to be produced.

In addition, when unlocking of the locking mechanism is performed and the disk tray 40 is ejected to the outside of the casing 10 by the disk tray extruder mechanism 44, restoring force of the elastic member 65 deformed by pressure to the inner side inner wall part 11r side by abutment of the introduction side abutment part 61 with respect to the introduction/ejection directions (x direction) causes the entrapped part 65s to withdraw from within the groove section 63 of the introduction side abutment part 61, and the part pressed to the inner side inner wall part 11r side by the introduction side abutment part 61 pushes the disk tray 40 in the ejection direction via the introduction side abutment part 61. By this, when the disk tray 40 is ejected, since the warping deformation restraining mechanism 60 does not produce scratch or friction that prevents the ejection, the disk tray 40 can be smoothly ejected to the outside of the casing 10.

In the aforementioned embodiment, in the ordinary mode of the inner part abutment part 62 at the predetermined introduction position, since the entrapped part 65s of the elastic member 65, not only abuts on the side-wall parts 63u, 63d opposed to each other in the height direction (z direction) of the groove section 63 of the introduction side abutment part 61, but also may cause elastic pressure in the upward and downward directions (z direction) from the abutment part to act.

FIG. 4D, 4E show modifications of the inner part abutment part 62 shown in FIG. 4C.

FIG. 4D shows a configuration in which the inner part abutment part 62 is formed of a complex member comprising two kinds of elastic members 65, 66 whose elastic forces are different from one another, and the outer circumferential surface of the elastic member 65 on and with which the introduction side abutment part 61 of the disk tray 40 abuts and engages, is coated by an elastic member 66 having the rigidity with lower elasticity than that of the elastic member 65. By this, flexure deformation toward the outside including the upward and downward directions of the elastic member 65 is prohibited. Thereby, when the pressed part is deformed by pressure toward the inner side inner wall part 11r side with respect to introduction/ejection directions (x direction), it is possible to increase the amount of entrapment into the groove section 63 of the inner part abutment part 62 in the peripheral part thereof.

FIG. 4E shows an example in which the inner part abutment part 62 is configured with a leveled elastic member 65, and the small diameter portion 65j thereof is fit in and fixed to the mounting hole 11h formed on the inner side inner wall part 11r. By this, enlarged diameter part of the large diameter portion 65k of the elastic member 65 on which the introduction side abutment part 61 of the disk tray 40 abuts is supported by the inner side inner wall part 11r of the bottom casing 11 with respect to the introduction/ejection directions (x direction), and in the ordinary mode of the inner part abutment part 62, even when the introduction side abutment part 61 of the disk tray 40 abutting and engaging thereon is to be displaced in the upper side or lower side, the inner part abutment part 62 is supported in the upward and downward directions by the bottom casing 11 via the small diameter portion 65j in the upward and downward directions. Therefore, the inner part abutment part 62 becomes hard to undergo flexure, and it becomes possible to effectively restrain the displacement in the upward and downward directions of the introduction side abutment part 61.

Further, the abutment surface 65o of the elastic member 65 of the inner part abutment part 62 in these embodiments are not limited to the planner shape, and they may have a curved surface and convex shape as shown in FIG. 4E. Further, also the shape of the inner part abutment part 62 itself may be any shape as long as the pressed part and the periphery of elastic member 65 is entrapped in the groove section 63 of the introduction side abutment part 61 by being pressed by the abutment on the introduction side abutment part 61, and the entrapped part 65s abuts on the side-wall parts 63u, 63d opposed to each other in the height direction (z direction) of the groove section 63.

The present embodiment is not limited to the inner part abutment part 62 provided for the bottom casing 11 in this way, and various modifications may be possible also for the configuration of the introduction side abutment part 61 provided for the disk tray 40.

For example, the cross-sectional shape of the groove section 63 of the introduction side abutment part 61 is not limited to U-shape, and it may not be the groove section 63 as long as it is the concave portion in which side-wall parts 63u, 63d opposed to each other in the height direction (z direction) are formed.

Further, in the state in which the disk tray 40 is introduced to the predetermined introduction position within the casing 10, it is not necessary that the elastic member 65 of the inner part abutment part 62 of the bottom casing 11 abuts on the whole circumferential surfaces of the concave part as long as it abuts on the side-wall parts 63d and 63u mutually opposed vertically in the height direction (z direction), restrains the introduction side abutment part 61 of the disk tray 40 from being displaced in the upward and downward directions (z direction), to restrain warping deformation in the upward and downward directions (z direction) of the central part in the width direction (y direction) of the disk tray 40 and resonance phenomenon that produces vibration displacement of the center part in the width direction (y direction) of the disk tray 40 in the upward and downward directions (z direction). In that process, a large vibration damping effect can be obtained if only the elastic member 65 abuts on the side-wall parts 63d and 63u mutually opposed vertically in the height direction (z direction), so as to be at a position from which the distances from both first guide mechanism 30a and the second guide mechanism 30b along the width direction (y direction) are substantially equal to one another, which is the part at which the displacement is particularly large in the mode of warping deformation in the upward and downward directions (z direction) of the disk tray 40, in other words, so as to be positioned on the dashed line in FIG. 3.

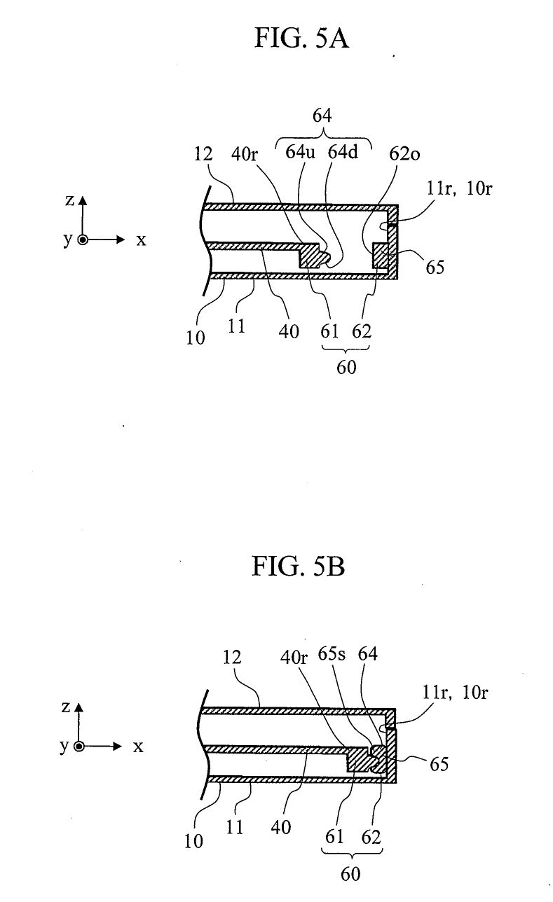

FIG. 5 is a schematic diagram of the second embodiment of the warping deformation restraining mechanism, and a general cross-section of the optical disk drive device in which the back side part in the front and back directions (x direction) of the optical disk drive device is viewed in the direction indicated by arrows B-B in FIG. 1. FIG. 5A shows a state in which the disk tray 40 is ejected to the outside from the opening 13 of casing 10, and FIG. 5B shows a state in which the disk tray 40 is introduced to a predetermined introduction position within the casing 10.

In the warping deformation restraining mechanism 60 of the present embodiment, a protruding portion 64 is formed on the abutment surface of the introduction side abutment part 61, instead of forming the groove section 63 or the concave portion as in the first embodiment shown in FIG. 4. The elastic member 65 of the inner part abutment part 62, by being pressed by the abutment on the protruding portion 64 of the introduction side abutment part 61 of the disk tray 40 introduced, evaginates in its pressed part and its periphery around the periphery of the protruding portion 64 as shown in FIG. 5B, and the elastic member 65 is deformed to surround the outer circumferential part of the protruding portion 64 in the ordinary mode of the inner part abutment part 62 at the predetermined introduction position, so as to abut on both the circumferential parts 64u, 64d opposed to each other in the height direction (z direction) of the protruding portion 64.

As a result, in the ordinary mode of the inner part abutment part 62 at the predetermined introduction position, when warping deformation in the upward and downward directions (z direction) of the center part in the width direction (y direction) of the disk tray 40 is to be caused, in the same way as the first embodiment, a restraining force to restrain the warping deformation in the upward and downward directions (z direction) of the center part in the width direction (y direction) of the disk tray 40 acts from the abutment parts of the elastic member 65 on which the circumferential parts 64u, 64d of the protruding portion 64 respectively abut.

Then, also when the disk tray 40, or parts mounted on the disk tray 40 are vibrated at the specific natural mode of vibration thereof, the abutment parts of the elastic member 65 on which the circumferential parts 64u, 64d of the protruding portion 64 respectively abut, causes an elastic pressing force in the direction inverse to the displacement direction to act on the introduction side abutment part 61 that is to be displaced at a specific natural mode of vibration in the upward and downward directions (z direction). Therefore, it is possible to restrain the resonance phenomenon that produces vibration displacement of the center part in the width direction of the disk tray 40 in the upward and downward directions.

Regarding the shape and the number of the protruding portion 64, the number is arbitrary as long as the shape has the circumferential parts 64u, 64d opposed to each other in the height direction (z direction) of the protruding portion 64. Further, the protruding portion 64 may be the introduction side distal end part (back side distal end part) 40r itself of the disk tray 40. Further, also for the shape itself of the inner part abutment part 62, any shape may be applied as long as the pressed part and the periphery thereof, by being pressed by the abutment to the introduction side abutment part 61, go around the outer circumference of the introduction side abutment part 61 and the part 65s having gone around abuts on the circumferential parts 64u, 64d opposed to each other in the height direction (z direction) of the protruding portion 64.

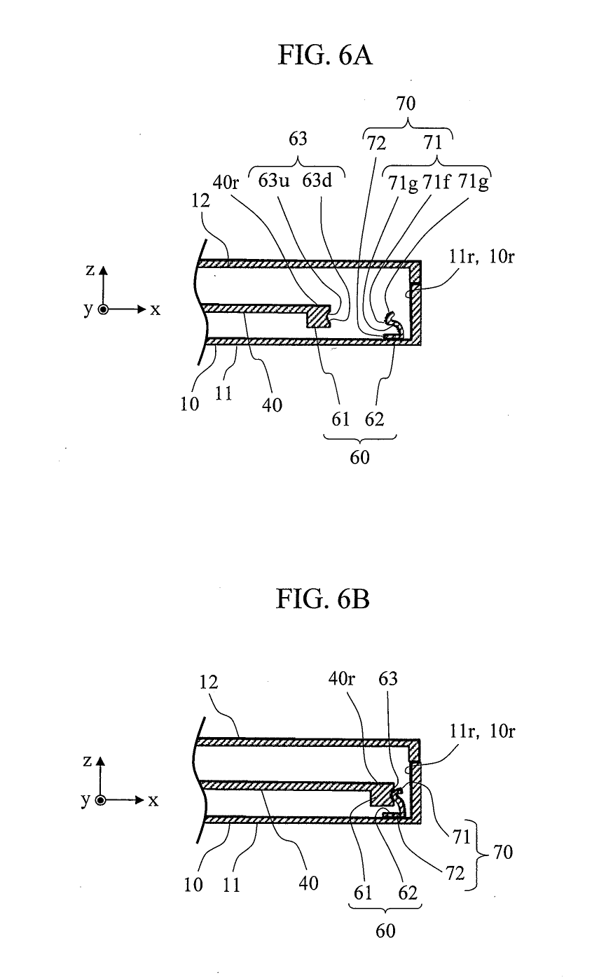

FIG. 6 is a schematic diagram of the third embodiment of the warping deformation restraining mechanism, which is a general cross-section in which the back side part in the front and back directions of the optical disk drive device (x direction) is viewed from the direction indicated by arrows B-B in FIG. 1. FIG. 6A shows a state in which the disk tray 40 is ejected to the outside from the opening 13 of the casing 10, and FIG. 6B shows a state in which the disk tray 40 is introduced to a predetermined introduction position within the casing 10.

In the warping deformation restraining mechanism 60 of the present embodiment, the elastic member 65 of the inner part abutment part 62 is formed by a plate spring member 70 instead of the elastic material having an elastic deformation property, and also a vibration dumping (vibration-proof) property, as in the first embodiment shown in FIG. 4.

The plate spring member 70 is, as shown in FIG. 6, formed so that bent tip part 71 having cross-sectional shape viewed along the width direction (y direction) of the disk tray 40 that is bent into the dogleg shape and the support tip part 72 supporting the bent tip part 71 so as to allow tilt thereof and constituting a mounting part against the casing 10 are continuously formed. The bent tip part 71 has such a bent shape that the projection distal end part 71f of the dogleg shape can be entrapped into the U-shaped groove section 63 formed in the introduction side abutment part 61 of the disk tray 40. Further, both vane parts 71g, 71g sandwiching the projection distal end part 71f of the bent tip part 71, are expanded and contracted so as to come close to and spaced apart from one another with the projection distal end part 71f as the center. The bent tip part 71 is formed so that, in the natural state, when the projection distal end part 71f is inserted in the groove section 63 of the introduction side abutment part 61 of the disk tray 40, each of the vane parts 71g, 71g can abut on each of the side-wall parts 63u, 63d opposed to each other in the height direction (z direction) of the groove section 63 or the peripheral parts thereof.

The support tip part 72 is formed continuously with one vane part 71g of the bent tip part 71 so that the height position of the projection distal end part 71f of the bent tip part 71 is adjusted to the height position of the groove section 63 of the introduction side abutment part 61 of the disk tray 40 and the bent tip part 71 is supported to be tiltable. The support tip part 72 is screwed at a predetermined position of the bottom face of the bottom casing 11 by a not-shown screw.

By this, at a predetermined introduction position at which the movement in the introduction/ejection directions (x direction) of the disk tray 40 is locked by the locking mechanism, the mode in which, in the plate spring member 70 of the inner part abutment part 62, the bent tip part 71 is tilted to the introduction side than the case of the natural state against the support tip part 72, and in the bent tip part 71, the projection distal end part 71f is housed in the groove section 63 of the introduction side abutment part 61 of the disk tray 40, each of the vane parts 71g, 71g abuts on each of the side-wall parts 63u, 63d opposed to each other in the height direction (z direction) of the groove section 63 or its peripheral pars thereof, is the ordinary mode.

As a result, in the ordinary mode of the plate spring member 70 at the predetermined introduction position, when warping deformation in the upward and downward directions (z direction) of the center part in the width direction (y direction) of the disk tray 40 is to be caused, a restraining force to restrain warping deformation in the upward and downward directions (z direction) of the center part in the width direction (y direction) of the disk tray 40 acts from each of vane parts 71g, 71g of the bent tip part 71 respectively abutting on the side-wall parts 63u, 63d of groove section 63 formed on the introduction side abutment part 61 of the disk tray 40, in the same way as the first embodiment.

Further, also when the disk tray 40, or a part mounted on the disk tray 40 is vibrated at the specific natural mode of vibration, each of the vane parts 71g, 71g of the bent tip part 71 respectively abutting on the side-wall parts 63u, 63d of the groove section 63 formed on the introduction side abutment part 61 causes an elastic pressing force in the direction inverse to the displacement direction to act on the introduction side abutment part 61 to produce vibration displacement in the upward and downward directions (z direction) at the specific natural mode of vibration, and therefore the resonance phenomenon that produces vibration displacement of the center part in the width direction of the disk tray 40 in the upward and downward directions can be restrained.

In addition, when unlocking of the locking mechanism is performed and the disk tray 40 is ejected to the outside of the casing 10 by the disk tray extruder mechanism 44, a restoring force of the bent tip part 71 of the plate spring member 70 tilted by the abutment to the introduction side abutment part 61 with respect to the introduction/ejection directions (x direction) causes the projection distal end part 71f to withdraw from within the groove section 63 of the introduction side abutment part 61, and each of the vane parts 71g, 71g of the bent tip part 71 pushes the disk tray 40 in the ejection direction via the introduction side abutment part 61. By this, when the disk tray 40 is ejected, since the warping deformation restraining mechanism 60 does not produce scratch or friction that prevents the ejection, the disk tray 40 can be smoothly ejected to the outside of the casing 10.

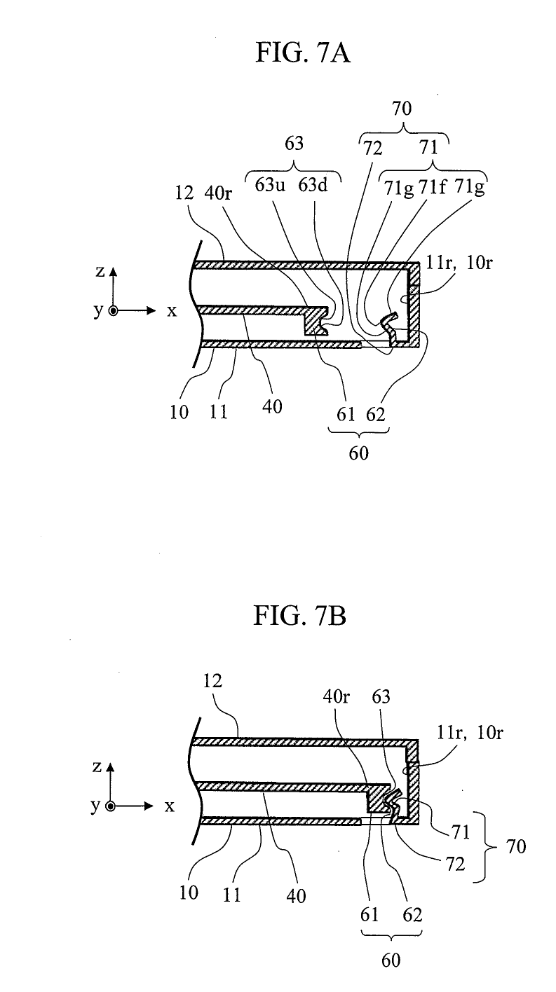

FIG. 7 is a schematic diagram of the fourth embodiment of the warping deformation restraining mechanism, which is a general cross-section in which the back side part in the front and back directions in the optical disk drive device (x direction) in FIG. 1 is viewed in the direction indicated by arrows B-B. FIG. 7A shows a state where the disk tray 40 is ejected to the outside from the opening 13 of the casing 10, and FIG. 7B shows a state in which the disk tray 40 is introduced to the predetermined introduction position within the casing 10.

In the warping deformation restraining mechanism 60 of the present embodiment, in the third embodiment shown in FIG. 6, the plate spring member 70 structured to be fixed to the predetermined position on the bottom face of the bottom casing 11 is formed such that the bottom face corresponding to the center part in the width direction (y direction) of the disk tray 40 close to the back side in the introduction/ejection directions (x direction) of the bottom casing 11 is cut and raised along the introduction/ejection directions (x direction) toward the inside in the introduction direction to form the bent tip part 71 and the part around the cut and raised portion is bent, so that bottom casing 11 also serves as the support tip part 72, and the support tip part 72 is integrally formed with the bottom casing 11.

In this case, as compared to the case where the plate spring member 70 is formed with a separate member, the number of parts is reduced to achieve cost reduction due to reduction of man-hour, etc.

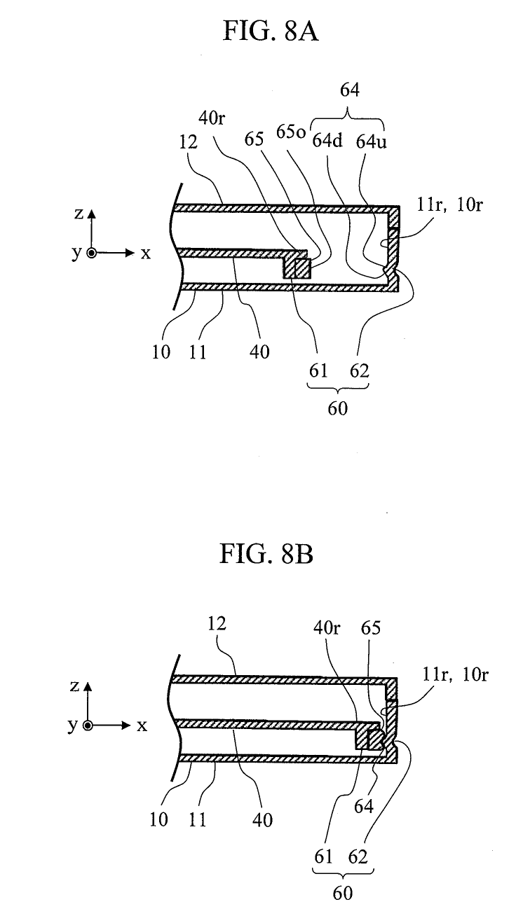

FIG. 8 is a schematic diagram of the fifth embodiment of the warping deformation restraining mechanism, which is a general cross-section in which the back side part in the front and back directions of the optical disk drive device (x direction) in FIG. 1 is viewed in the direction indicated by arrows B-B. FIG. 8A shows a state in which the disk tray 40 is ejected to the outside from the opening 13 of the casing 10, and FIG. 8B shows a state in which the disk tray 40 is introduced to the predetermined introduction position within the casing 10.

In the warping deformation restraining mechanism 60 of the present embodiment, in contrast to the second embodiment shown in FIG. 5, the introduction side abutment part 61 provided in the disk tray 40 is formed by the elastic member 65, and the inner part abutment part 62 provided on the bottom casing 11 is formed by the protruding portion 64. The introduction side abutment part 61 is configured so that the elastic member 65 is fixed in the center part in the width direction (y direction) of the introduction side distal end part (back side distal end part) 40r of the disk tray 40. In the illustrated example, the protruding portion 64 is formed on the inner side inner wall part 11r of the bottom casing 11 to protrude to be adjusted with the height position in the height direction (z direction) or the position in the width direction (y direction) so as to be opposed to the introduction side abutment part 61 of the disk tray 40. In machining the protruding portion 64, it is possible to form the protruding portion 64 together with forming the inner side of the bottom casing 11 on forming the bottom casing 11.

The protruding portion 64 of the inner part abutment part 62 presses the elasticity surface 65o by abutment on the elastic member 65 of the introduction side abutment part 61 of the disk tray 40 having been introduced. In the elastic member 65, by being pressed by the protruding portion 64, the pressed part and the periphery evaginate to the periphery of the protruding portion 64 as shown in FIG. 8B, and in the ordinary mode of the inner part abutment part 62 at the predetermined introduction position, the elastic member 65 is deformed to surround the outer circumferential part of the protruding portion 64, to abut on both the circumferential parts 64u, 64d opposed to each other in the height direction (z direction) of the protruding portion 64.

As a result, in an ordinary mode of the inner part abutment part 62 at the predetermined introduction position, when warping deformation is to be caused in the upward and downward directions (z direction) of the center part in the width direction (y direction) of the disk tray 40, in the same way as the first embodiment, restraining force restraining the center part in the width direction (y direction) of the disk tray 40 from causing warping deformation in the upward and downward directions (z direction) (force to restore the ordinary mode) is produced in the abutment part of the elastic member 65 abutting respectively on the circumferential parts 64u, 64d of the protruding portion 64.

Similarly, also when the disk tray 40, or a part mounted on the disk tray 40 is vibrated at the specific natural mode of vibration, on the abutment parts of the elastic member 65 abutting respectively on the circumferential parts 64u, 64d of the protruding portion 64, restraining force restraining the vibration of the center part in the width direction (y direction) of the disk tray 40 in the upward and downward directions (z direction) (force to restore the ordinary mode) is produced so that the resonance phenomenon that produces vibration displacement in the upward and downward directions in the center part in the width direction of the disk tray 40 can be restrained.

In the present embodiment, although protruding portion 64 is formed to project on the inner side inner wall part 11r of the bottom casing 11, it is also possible to attain similar working/effect by forming a concave portion on the groove section, or the like, instead of the protruding portion 64.

In this way, specific configurations of the warping deformation restraining mechanism 60 restraining the warping deformation mode by the resonance phenomenon of the disk tray 40 are not limited to the aforementioned embodiments as long as in the ordinary mode in which the disk tray 40 is introduced into the predetermined introduction position, and the center part in the width direction (y direction) of the introduction side distal end part (back side distal end part) 40r in the introduction/ejection directions (x direction) of the disk tray 40 is elastically supported in each of the upward and downward directions (z direction). Further, the warping deformation restraining mechanism 60 may be configured by combination of multiple kinds of warping deformation restraining mechanisms 60 in which, for example, the protruding portion 64 and the groove section (concave portion) 63 are alternately formed on a same face, etc.

### DESCRIPTION OF SYMBOLS

1 optical disk drive device, 10 casing, 11 bottom casing, 12 top casing, 13 opening, 20 circuit board, 30 guide mechanism, 31 guide rail, 32 rack slide, 33 rattle vibration prevention part, 34 pressing claw portion, 35 pressing claw portion, 36 stopper projection, 40 disk tray, 41 optical disk mount part, 42 opening, 43 front bezel, 44 disk tray extruder mechanism, 50 unit mechanism, 51 unit cover, 52 cut-out section, 55 spindle motor, 56 optical pickup, 60 warping deformation restraining mechanism, 61 introduction side abutment part, 62 inner part abutment part, 63 groove section, 64 protruding portion, 65, 66 elastic member, 70 plate spring member, 71 bent tip part, 71f projection distal end part, 71g vane, 72 support tip part.

What is claimed is:

1. A disk drive device comprising:
a casing comprising a top casing and a bottom casing;
a disk tray having a disk mount surface; and
a pair of guide mechanism parts that support each of both sides in a width direction of the disk tray along the disk mount surface, and guide, introduction/ejection of the disk tray against a predetermined introduction position within the casing,
wherein the disk drive device reproduces recorded information on the disk mounted on the disk mount surface of the disk tray introduced in the predetermined introduction position within the casing, or records information on the disk, and the disk drive device comprises:
an introduction side abutment part that is provided to be positioned at a center part with respect to the width direction of the disk tray between the pair of guide mechanism parts and with respect to introduction/ejection directions of the disk tray on distal end part in the introduction side of the disk tray, and in which a concave portion or a projection including a surface part facing in each of upward and downward directions of the disk tray vertical to each of the introduction/ejection directions and the width direction of the disk tray are formed to face in the introduction direction; and
an inner part abutment part formed in an introduction direction distal end part side in the device casing to be opposed to the introduction side abutment part of the disk tray to be introduced in the predetermined introduction position within the casing and formed of an elastic member, and
wherein in an ordinary mode which is a mode in which the disk tray is introduced in the predetermined introduction position within the casing, the concave portion or projection on the introduction side abutment part abuts on the elastic member of the inner part abutment part, and the elastic member abuts on the surface part facing in each of the upward and downward directions of the disk tray of the concave portion or projection of the introduction side abutment part.

2. The disk drive device according to claim 1, wherein the elastic member is formed of a plate spring member including a bent tip part, and the plate spring member is formed by cutting a part of the bottom casing and raising the cut portion.

3. The disk drive device according to claim 1, wherein the elastic member is formed of an elastic material having both an elastic deformation property and a vibration-damping property.

4. The disk drive device according to claim 1, wherein the concave portion or projection is formed of a groove section or a protruding portion formed on a surface facing in the introduction side in the introduction side abutment part.

5. A disk drive device comprising:
a casing comprising a top casing and a bottom casing;
a disk tray having a disk mount surface; and
a pair of guide mechanism parts that support each of both sides in a width direction of the disk tray along the disk mount surface, and guide introduction/ejection of the disk tray against a predetermined introduction position within the casing,
wherein the disk drive device reproduces recorded information on the disk mounted on the disk mount surface of the disk tray introduced in the predetermined introduction position within the casing, or records information on the disk, and the disk drive device comprises:
an introduction side abutment part that is provided to be positioned at a center part with respect to the width direction of the disk tray between the pair of guide mechanism parts and with respect to introduction/ejection directions of the disk tray on distal end part in the introduction side of the disk tray; and
an inner part abutment part formed in an introduction direction distal end part side in the device casing to be opposed to the introduction side abutment part of the disk tray to be introduced in the predetermined introduction position within the casing and in which a concave portion or a projection including a surface part facing in each of upward and downward directions of the disk tray vertical to each of the introduction/ejection directions and the width direction of the disk tray are formed to face in the ejection direction, and
wherein in an ordinary mode which is a mode in which the disk tray is introduced in the predetermined introduction position within the casing, the concave portion or projection on the inner part abutment part abuts on the elastic member of the introduction side abutment part, and the surface part facing in each of the upward and downward directions of the disk tray of the concave portion or projection of the inner part abutment part abuts on the elastic member of the introduction side abutment part.
